(19) United States
(12) Patent Application Publication
(10) Pub. No.: US 2011/0256425 A1
(43) Pub. Date: Oct. 20, 2011

(54) LUBRICATING FILM, MAGNETIC DISK AND MAGNETIC HEAD

(76) Inventors: Haruo Kasai, Hyogo (JP); Akinobu Wakabayashi, Hyogo (JP)

(21) Appl. No.: 13/129,446

(22) PCT Filed: Nov. 19, 2008
(86) PCT No.: PCT/JP2008/071477

§ 371 Date: May 16, 2011

(51) Int. Cl. G11B 5/725; B05D 3/02; B05D 3/06; B05D 5/00

(52) U.S. Cl. 428/833.3; 428/814; 427/521

(57) ABSTRACT

A magnetic disk or magnetic head having a lubrication film of a lubricant bonded in a ratio of at least 99% to a protective carbon film on a magnetic disk member, the lubricant containing a perfluoropolyether compound (Q)

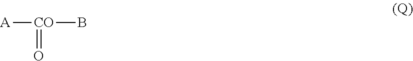

wherein A is alkyl having 1 to 10 carbon atoms, fluoroalkyl having 1 to 10 carbon atoms, F(CF₂CF₂CF₂O)m-CF₂CF₂—, F[CF(CF₃)CF₂O]n-CF(CF₃)— or a group of the formula (a) given below, B is hydrogen, alkyl having 1 to 10 carbon atoms, fluoroalkyl having 1 to 10 carbon atoms, F(CF₂CF₂CF₂O)m-CF₂CF₂—CH₂—, F[CF(CF₃)CF₂O]n-CF(CF₃)—CH₂— or a group of the formula (b) given below

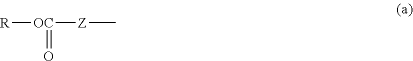

wherein R is hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—, Z is —CF₂O(CF₂CF₂O)rCF₂—, —CF₂O(CF₂CF₂O)p(CF₂O)qCF₂— or —CF₂CF₂O(CF₂CF₂CF₂O)m-CF₂CF₂—

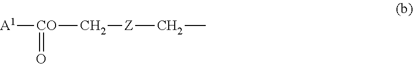

wherein A¹ is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, Z is the same as defined above, and m, n, p, q and r are each a real number of 5 to 50.

### TECHNICAL FIELD

The present invention relates to lubrication films having a very high bonding ratio, a process for preparing the lubrication film, and magnetic disks and magnetic heads wherein the lubrication film is used.

### BACKGROUND ART

With increases in the recording density of magnetic disks, the distance between the magnetic disk serving as a recording medium and the head for recording information or playback becomes almost nil close to contact therebetween. The disk is provided on its outermost surface with a lubricant film for diminishing the abrasion due to the contact of the head or sliding thereof or for preventing contamination of the disk surface.

Compounds containing a fluorine atom are generally used as such lubricants. Although it is common practice to prepare the lubricant film by coating the disk surface with the lubricant and thereafter heat-treating the resulting film to promote the formation of a fixed lubricant layer, this treatment requires several tens of minutes.

In place of the heat treatment, it is alternatively practice to irradiate the lubricant film with ultraviolet rays with use of a low-pressure mercury lamp. The ultraviolet treatment is capable of forming a fixed lubricant film within a very short period of several tens of seconds unlike the heat treatment, further ensuring reduced surface energy and giving improved durability to the magnetic disk. In providing optical recording media instead of magnetic recording media, it is known to use ultraviolet rays having a wavelength of 254 nm or 185 to 254 nm in order to form a fixed layer of lubricant film on a solid protective layer. (e.g., Patent Literature 1 and 2).

Also known are various lubricants comprising an ester compound of a perfluoropolyether compound and a carboxylic acid (e.g., Patent Literature 3), although nothing is mentioned about formation of a fixed lubricant layer with ultraviolet rays.

Furthermore, ultraviolet rays of up to 200 nm in wavelength are effective for forming fixed lubricant layers (e.g., Nonpatent Literature 1). When ultraviolet rays having a wavelength of up to 240 nm are used for irradiating the lubricant in an oxygen-containing environment in order to convert oxygen molecules to ozone, the lubricant becomes more deteriorated due to oxidation with ozone, causing the lubricant film to degrade or disappear. Accordingly, if ultraviolet rays of up to 240 nm in wavelength are to be used, there is a need to prepare an oxygen-free atmosphere such as an inert gas atmosphere or vacuum.

While ultraviolet rays of 254 nm are used for irradiation to provide a fixed lubricant layer over a protective film according to Patent Literature 1, the fixed layer is thereafter used without washing with a solvent. Consequently, the lubricant failing to bond to the protective film and remaining adsorbed physically by the film and unremoved will spatter when data is recorded or reproduced, to result in impaired lubricity.

When ultraviolet rays of 185 to 254 nm are projected to provide a fixed layer of lubrication film over the protective film according to Patent Literature 2, the fixed layer is subsequently washed with a solvent before use. Thus, the lubricant failing to bond to the protective layer and physically adsorbable has been removed, whereas since the solvent used is perfluorooctane (C₈F₁₈), perfluorohexane (C₆F₁₄), C₄F₉OCH₃, C₄F₉OC₂H₅, GALDEN or like solvent which is low in solubility, the physically removable lubricant can not be removed effectively even if appearing removable to a high ratio, and becomes spattered when used for recording or playback to entail reduced lubricity.
Patent Literature 1: JP1999-7657A
Patent Literature 2: JP2001-28149A
Patent Literature 3: JP1993-194970A
Nonpatent Literature 1: Proceedings of ASIATRIB 2006 Kanazawa, Japan, 2006.10, p 603

An object of the present invention is to provide a lubrication film extremely high in bonding ratio, a process for preparing a lubricant film with use of ultraviolet rays but without the necessity of preparing an inert gas atmosphere or vacuum, a process for preparing a lubrication film which is extremely high in lubricant bonding ratio, and a magnetic head and magnetic disk having the lubrication film obtained by this process.

### DISCLOSURE OF THE INVENTION

The present invention provides the following.

1. A magnetic disk having a lubrication film of a lubricant bonded in a ratio of at least 99% to a protective carbon film on a magnetic disk member, the lubricant containing a perfluoropolyether compound (Q).

2. A magnetic head having a lubrication film of a lubricant bonded in a ratio of at least 99% to a protective carbon film on a magnetic head member, the lubricant containing a perfluoropolyether compound (Q).

3. A process for preparing a lubrication film comprising a lubricant having a bonding ratio of at least 99%, the process comprising coating a protective film on a magnetic disk or magnetic head with a lubricant containing a perfluoropolyether compound (Q), irradiating the resulting coating with ultraviolet rays having a main wavelength of 240 to 380 nm using a low-pressure mercury lamp to form a fixed lubricant layer, and washing out the lubricant remaining unbonded and physically adsobable with a fluorine-containing solvent having a solubility parameter of at least 6.5.

4. A process for preparing a lubrication film comprising a lubricant having a bonding ratio of at least 99%, the process comprising coating a protective film on a magnetic disk or magnetic head with a lubricant containing a perfluoropolyether compound (Q), irradiating the resulting coating with ultraviolet rays having a main wavelength of 254 nm using a low-pressure mercury lamp to form a fixed lubricant layer, and washing out the lubricant remaining unbonded and physically adsobable with a fluorine-containing solvent having a solubility parameter of at least 6.5.

5. A process for preparing a lubrication film comprising a lubricant having a bonding ratio of at least 99%, the process comprising coating a protective film on a magnetic disk or magnetic head with a lubricant containing at least one of compounds (I)˜(IV), irradiating the resulting coating with ultraviolet rays having a main wavelength of 254 nm using a low-pressure mercury lamp to form a fixed lubricant layer, and washing out the lubricant remaining unbonded and physically adsobable with a fluorine-containing solvent having a solubility parameter of at least 6.5.

6. A magnetic disk provided over a surface of a protective carbon film on a magnetic disk member with a lubrication film obtained by the process defined in the para. 3 above.

7. A magnetic disk provided over a surface of a protective carbon film on a magnetic disk member with a lubrication film obtained by the process defined in the para. 4 above.

8. A magnetic disk provided over a surface of a protective carbon film on a magnetic disk member with a lubrication film obtained by the process defined in the para. 5 above.

9. A magnetic head provided over a surface of a protective carbon film on a magnetic head member with a lubrication film obtained by the process defined in the para. 3 above.

10. A magnetic head provided over a surface of a protective carbon film on a magnetic head member with a lubrication film obtained by the process defined in the para. 4 above.

11. A magnetic head provided over a surface of a protective carbon film on a magnetic head member with a lubrication film obtained by the process defined in the para. 5 above.

The perfluoropolyether compound of the present invention is represented by the formula (Q)

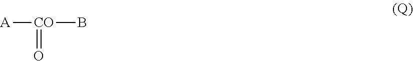

wherein A is alkyl having 1 to 10 carbon atoms, fluoroalkyl having 1 to 10 carbon atoms, F(CF₂CF₂CF₂O)m-CF₂CF₂—, F[CF(CF₃)CF₂O]n-CF(CF₃)— or a group of the formula (a) given below, B is hydrogen, alkyl having 1 to 10 carbon atoms, fluoroalkyl having 1 to 10 carbon atoms, F(CF₂CF₂CF₂O)m-CF₂CF₂—CH₂—, F[CF(CF₃)CF₂O]n-CF(CF₃)—CH₂— or a group of the formula (b) given below.

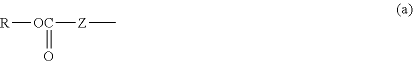

wherein R is hydrogen, alkyl having 1 to 10 carbon atoms, fluoroalkyl having 1 to 10 carbon atoms, F(CF₂CF₂CF₂O)m-CF₂CF₂—CH₂—, or F[CF(CF₃)CF₂O]n-CF(CF₃)—CH₂—, Z is —CF₂O(CF₂CF₂O)rCF₂—, —CF₂O(CF₂CF₂O)p(CF₂O)qCF₂— or —CF₂CF₂O(CF₂CF₂CF₂O)m-CF₂CF₂—

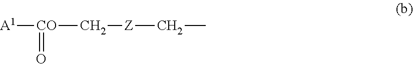

wherein A¹ is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, Z is the same as defined above, and m, n, p, q and r are each a real number of 5 to 50.

The perfluoropolyether compounds of the formula (Q) include the following compounds (I) to (IV).

Compounds (I) wherein A is F(CF₂CF₂CF₂O)m-CF₂CF₂— or F[CF(CF₃)CF₂O]n-CF(CF₃)—, B is hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃) —CH₂—.

Compounds (II) wherein A is alkyl having 1 to 10 carbon atoms or fluoroalkyl having 1 to 10 carbon atoms, B is F(CF₂CF₂CF₂O)m-CF₂CF₂—CH₂— or F[CF(CF₃)CF₂O]n-CF(CF₃)—CH₂—.

Compounds (III) wherein A is ROCO—Z—, R being hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—, Z is —CF₂O(CF₂CF₂O)rCF₂—, —CF₂O(CF₂CF₂O)p(CF₂O)qCF₂— or —CF₂CF₂O(CF₂CF₂CF₂O)m-CF₂CF₂—, and B is hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—.

Compounds (IV) wherein A is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, B is A¹COOCH₂—Z—CH₂—, A¹ is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, Z is —CF₂O(CF₂CF₂O)rCF₂—, —CF₂O(CF₂CF₂O)p(CF₂O)qCF₂— or —CF₂CF₂O(CF₂CF₂CF₂O)m-CF₂CF₂—.

In the present invention, examples of alkyl group having 1 to 10 carbon atoms are methyl, ethyl, propyl, butyl, hexyl, octyl and decyl.

Examples of fluoroalkyl group having 1 to 10 carbon atoms are fluoromethyl, fluoroethyl, fluoropropyl, fluorobutyl, fluorohexyl, fluorooctyl, fluorodecyl, 1,1,1-trifluoropropyl, and fluoroalkyl group having 1 to 10 carbon atoms which is substituted by fluorine atom at any position.

Compound (Q) can be prepared by a method disclosed in Japanese patent application No. 2007-141710 as mentioned below.

### Process for Preparing Compounds (I) and (III)

The compounds (I) and (III) of the invention are prepared, for example, by the process to be described below. These compounds are perfluoropolyether compounds having an ester bond at the terminal of a perfluoropolyether chain. They are prepared, for example, by mixing a perfluoropolyether having a carboxyl group, an alcohol, and an acid catalyst or condensation agent and subjecting the mixture to a dehydration condensation reaction. Preferably, the ratio of the perfluoropolyether having carboxyl to the alcohol is 1 to 2 moles of the latter per mole of the former. More specifically, p-toluenesulfonic acid hydrate serving as the acid catalyst is added to a mixture of a perfluoropolyether having carboxyl and an alkyl alcohol or fluoroalkyl alcohol or perfluoropolyether alcohol.

The acid catalyst is used in an amount of 0.1 to 2.0 equivalents, preferably 0.1 to 1.0 equivalent, to the perfluoropolyether. The mixture is subsequently stirred at 60 to 70° C. for 0 to 48 hours, preferably for 24 to 48 hours, whereby the desired product is obtained.

Examples of perfluoropolyethers having carboxyl are Demnum-SH, product of Daikin Industries, Ltd., Krytox-157FS, product of DuPont, Fomblin Z-DIAC, product of Solvey Solexis Inc., etc. The chemical structure of these products is F(CF₂CF₂CF₂O)ₘ—CF₂CF₂—COO—H wherein m is 5 to 50, or F[CF(CF₃)CF₂O]ₙ—CF(CF₃)COO—H wherein n is 5 to 50, or H—OOC—CF₂O—(CF₂CF₂O]ₚ—(CF₃O)_{q}—CF₂—COO—H wherein p and q are each 5 to 50. These compounds each have a molecular weight distribution and about 1000 to 8000 in weight-average molecular weight.

The followings are representative examples of the Compounds (I) and (III).

### Compounds (I):

### F(CF₂CF₂CF₂O)m-CF₂CF₂—COO—CH₃,

### F(CF₂CF₂CF₂O)m-CF₂CF₂—COO—CH₂CF₃,

### F(CF₂CF₂CF₂O)m-CF₂CF₂—COO—CH₂CF₂CF₂CF₃,

F(CF₂CF₂CF₂O)m-CF₂CF₂—COO—CH₂CH₂CF₂CF₂CF₂CF₂CF₂CF₃,
m=5 to 50, preferably m=5 to 35, more preferably m=5 to 25.
F[CF(CF₃)CF₂O]n-CF(CF₃)—COO—CH₃,
F[CF(CF₃)CF₂O]n-CF(CF₃)—COO—CH₂CF₃,
F[CF(CF₃)CF₂O]n-CF(CF₃)—COO—CH₂CF₂CF₂CF₃,
F[CF(CF₃)CF₂O]n-CF(CF₃)—COO—CH₂CH₂CF₂CF₂CF₂CF₂CF₂CF₃,
n=5 to 50, preferably n=5 to 35, more preferably n=5 to 25.
F(CF₂CF₂CF₂O)m-CF₂CF₂—COO—CH₂—CF₂CF₂—(OCF₂CF₂CF₂)m-F, F[CF(CF₃)CF₂O]n-CF(CF₃)—COO—CH₂—CF(CF₃)—[OCF₂CF(CF₃)]n-F, F[CF(CF₃)CF₂O]n-CF(CF₃)—COO—CH₂—CF₂CF₂—(OCF₂CF₂CF₂)m-F,

m, n=5 to 50, preferably m, n=5 to 35, more preferably m, n=5 to 25. These compounds each have a molecular weight distribution and about 1000 to 16000 in weight-average molecular weight.

### Compounds (III):

### CH₃—OOC—CF₂O—(CF₂CF₂O)p-(CF₂O)q-CF₂—COO—CH₃,

CF₃CH₂—OOC—CF₂O—(CF₂CF₂O)p-(CF₂O)q-CF₂—COO—CH₂CF₃,
CF₃CF₂CF₂CH₂—OOC—CF₂O—(CF₂CF₂O)p-(CF₂O)q-CF₂—COO—CH₂CF₂CF₂CF₃CF₃CF₂CF₂CF₂CF₂CF₂CH₂CH₂—OOC—CF₂O—(CF₂CF₂O)p-(CF₂O)q-CF₂—COO—CH₂CH₂CF₂CF₂CF₂CF₂CF₂CF₃,

p, q=5 to 50, preferably p, q=5 to 35, more preferably p, q=5 to 25.

F(CF₂CF₂CF₂O)m-CF₂CF₂—CH₂—OOC—CF₂O—(CF₂CF₂O)p-(CF₂O)q-CF₂—COO—CH₂—CF₂CF₂—(OCF₂CF₂CF₂)m-F,
F[CF(CF₃)CF₂O]n-CF(CF₃)—CH₂—OOC—CF₂O—(CF₂CF₂O)p-(CF₂O)q-CF₂—COO—CH₂—CF(CF₃)—[OCF₂CF(CF₃)]n-F,

m, n, p, q=5 to 50, preferably m, n, p, q=5 to 35, more preferably m, n, p, q=5 to 25. These compounds each have a molecular weight distribution and about 1000 to 24000 in weight-average molecular weight.

### Process for Preparing Compounds (II) and (IV)

The compounds (II) and (IV) of the invention are prepared, for example, by the process to be described below. These compounds are perfluoropolyether compounds having an ester bond within the molecule of a perfluoropolyether chain. They are prepared, for example, by mixing a perfluoropolyether having a hydroxyl group, carboxylic acid (acid chloride), and an acid catalyst or condensation agent and subjecting the mixture to a dehydration condensation reaction. Preferably, the ratio of the perfluoropolyether having hydroxyl to the carboxylic acid (acid chloride) is 1 to 2 moles of the latter per mole of the former. More specifically, p-toluenesulfonic acid hydrate serving as the acid catalyst is added to a mixture of a perfluoropolyether having hydroxyl at the terminal and a fatty acid or perfluoropolyether having hydroxyl. The acid catalyst is used in an amount of 0.1 to 2.0 equivalents, preferably 0.1 to 1.0 equivalent, to the perfluoropolyether. The mixture is subsequently stirred at 60 to 70° C. for 0 to 48 hours, preferably for 24 to 48 hours, whereby the desired product is obtained.

Examples of perfluoropolyether having a hydroxyl group are Demnum-SA (Daikin Industries Co., Ltd.) and Fomblin Z-dol (Solvey Solexis Inc. Chemical structures thereof are F(CF₂CF₂CF₂O)m-CF₂CF₂—CH₂—OH, m=5˜50, and HO—CH₂—CF₂O—(CF₂CF₂O)p-(CF₂O)q-CF₂—CH₂—OH, p, q=5 to 50.

These compounds each have a molecular weight distribution and about 1000 to 8000 in weight-average molecular weight.

The followings are representative examples of the Compounds (II) and (IV).

### Compounds (II);

CH₃—COO—CH₂—CF₂CF₂—(OCF₂CF₂CF₂)m-F,
CH₃CH₂—COO—CH₂—CF₂CF₂—(OCF₂CF₂CF₂)m-F,
CH₃CH₂CH₂CH₂—COO—CH₂—CF₂CF₂—(OCF₂CF₂CF₂)m-F

m=5 to 50, preferably m=5 to 35, more preferably m=5 to 25.

CH₃—COO—CH₂—CF(CF₃)—[OCF₂CF(CF₃)]n-F,
CH₃CH₂—COO—CH₂—CF(CF₃)—[OCF₂CF(CF₃)]n-F,
CH₃CH₂CH₂CH₂—COO—CH₂—CF(CF₃)—[OCF₂CF(CF₃)]n-F,

n=5 to 50, preferably n=5 to 35, more preferably n=5 to 25. These compounds each have a molecular weight distribution and about 1000 to 8000 in weight-average molecular weight.

### Compounds (IV);

CH₃—COO—CH₂—CF₂O—(CF₂CF₂O)p—(CF₂O)q—CF₂—CH₂—OOC—CH₃,
CH₃CH₂—COO—CH₂—CF₂O—(CF₂CF₂O)p—(CF₂O)q—CF₂—CH₂—OOC—CH₂CH₃,
CH₃CH₂CH₂CH₂—COO—CH₂—CF₂O—(CF₂CF₂O)p-(CF₂O)q—CF₂—CH₂—OOC—CH₂CH₂CH₂CH₃,
p, q=5 to 50, preferably p, q=5 to 35, more preferably p, q=5 to 25.
F(CF₂CF₂CF₂O)m-CF₂CF₂—COO—CH₂—CF₂O—(CF₂CF₂O)p—(CF₂O)q—CF₂—CH₂—OOC—CF₂CF₂—(OCF₂CF₂CF₂)m-F,
F[CF(CF₃)CF₂O]n-CF(CF₃)—COO—CH₂—CF₂O—(CF₂CF₂O)p—(CF₂O)q—CF₂—CH₂—OOC—CF(CF₃)—[OCF₂CF(CF₃)]n-F,
m, n, p, q=5 to 50, preferably m, n, p, q=5 to 35, more preferably m, n, p, q=5 to 25. These compounds each have a molecular weight distribution and about 1000 to 24000 in weight-average molecular weight.

Examples of compounds (Q) of the invention are Demnum-SH, product of Daikin Industries, Ltd., Krytox-157FS, product of DuPont, Fomblin Z-DIAC, product of Solvey Solexis Inc., etc.

[2] Method of Coating Magnetic Disk or Magnetic Head with Compound (Q)

The compound of the present invention is applied to the magnetic disk or magnetic head over the surface of a protective carbon film thereon, for example, by a dip method wherein the compound is used as diluted with a solvent, or by spin coating method. The dip method is preferred. Examples of solvents for the dip method are PF-5060, PF-5080, HFE-7100 and HFE-7200 which are products of 3M, and Vertrel-XF, product of DuPont. The compound is diluted to a concentration of up to 1 wt. %, preferably 0.01 to 0.3 wt. %.

Process for Preparing Lubrication Film with Use of Ultraviolet Rays

The magnetic disk or magnetic head having a protective carbon film and coated with the compound (Q) of the invention is treated with ultraviolet rays over the film surface, for example, in the following manner. The magnetic disk or magnetic head coated with the lubricant is placed into a box provided with a low-pressure mercury lamp impermeable to ultraviolet rays having a wavelength of 185 nm to irradiate the coating. The ultraviolet rays to be applied are 240 to 380 nm, preferably 240 to 300 nm, more preferably 254 nm, in main wavelength. The irradiation time is 1 to 1800 seconds, preferably 1 to 600 seconds, more preferably 1 to 120 seconds.

While the compound (Q) of the invention is used singly, the compound can be otherwise used as admixed in a desired ratio, for example, with Fomblin Zdol, Ztetraol, Zdol TX or AM manufactured by Solvay Solexis Inc., Demnum produced by Daikin Industries, Ltd., Krytox, product of DuPont, or the like. In this case, it is thought feasible to use a mixture solution for the dip coating method, or to apply a different compound (such as Fomblin Zdol, Ztetraol, Zdol TX or AM manufactured by Solvay Solexis Inc., Demnum produced by Daikin Industries, Ltd., or Krytox, product of DuPont) by repeating the dip method again after the ultraviolet treatment for the compound (Q) of the invention.

According to the invention, the lubrication film thus obtained is subsequently washed (rinsed) with a solvent to remove the lubricant remaining unbonded and physically adsorbable. This affords a lubrication film which is at least 99%, preferably 99 to 100%, more preferably 99.5% to 100%, most preferably 100%, in the bonding ratio of the lubricant.

The solvent to be used is a fluorine-containing solvent having an extremely high solubility of at least 6.5 in terms of solubility parameter. The term “solubility parameter (SP)” as used herein refers to a value defined by the regular solution theory introduced by Hildebrand and providing an estimate of solubility of solutions composed of two components. According to the regular solution theory, the force acting between a solvent and a solute is modeled as an intermolecular force only, so that the interaction for cohering liquid molecules can be considered to be the intermolecular force only. Since the cohesive energy of a liquid is equivalent to evaporation enthalpy, the solubility parameter is defined as σ=(ΔH/V−RT)^{1/2} from the molar evaporation heat ΔH and molar volume V. Thus, the parameter is calculated from the square root (cal/cm³)^{1/2} of evaporation heat required for evaporating a liquid of 1 molar volume. Usually used is a fluorine-containing solvent which is preferably 6.5 to 7.5, more preferably 6.5 to 7, in SP.

Examples of solvents having such high solubility and usable are Vertrel-XF (DuPont, SP=6.8, CF₃CF₂CFHCFHCF₃), AK-225G (product of Asahi Glass Co., Ltd., SP=6.9, a mixture of CF₃CF₂CHCl₂ and CClF₂CF₂CHClF), etc. The magnetic disk or magnetic head coated with the lubricant can be washed, for example, by dipping the coated article in a wash solvent. It is impossible to provide the lubricant as bonded to the desired ratio if the solvent is HFE-7100 (product of Sumitomo 3M, CF₃CF₂CF₂CF₂OCH₃) or PF-5080 (product of Sumitomo 3M, C₈F₁₈) which is up to 6.2 in SP.

The lubrication film obtained by irradiating the compound of the present invention can be given a surface having an unsaturated bond or dangling bond. The present compounds are therefore useful not only for magnetic disks and magnetic heads but also for optical magnetic recording devices, magnetic tapes or the like having a protective carbon film and organic materials, such as plastics, having no protective carbon film in forming a surface protective film.

### BRIEF DESCRIPTION OF THE DRAWINGS

FIG. 1 is a graph showing the result of a contact sliding test conducted for magnetic disks.

FIG. 2 is a graph showing the result of a durability test conducted for magnetic disks.

FIG. 3 is a diagram in section showing the construction of a magnetic disk of the invention.

FIG. 4 is a graph showing the result of a contact sliding test conducted for magnetic heads.

FIG. 5 is a diagram in section showing the construction of a magnetic head of the invention.

1 substrate, 2 recording layer, 3 protective layer, 4 lubrication layer, 5 substrate, 6 protective layer, 7 lubrication layer, 8 read/write, 9 magnetic disk

### BEST MODE OF CARRYING OUT THE INVENTION

The present invention will be described in greater detail with reference to Preparation Examples and Test Examples given below. However, the scope of the present invention is not limited to these examples.

### Preparation Example 1

### Preparation of F[CF(CF₃)CF₂O]ₙ—CF(CF₃)—COO—CH₃ (Compound 1)

A mixture solution of F[CF(CF₃)CF₂O]ₙ—CF(CF₃)—COOH (product of DuPont, Krytox-157FSL, 30.0 g), methanol (20.0 g) and p-toluenesulfonic acid (1.0 g) was refluxed at 65° C. with heating for 48 hours. The reaction mixture was washed with water and purified by column chromatography to obtain 6.7 g of the desired Compound 1. Compound 1 was a colorless transparent liquid. Compound 1 was identified by NMR with the result given below. Compound 1 was directly used for analysis.

¹⁹F-NMR (solvent: none, internal reference: CF₃CF₂CF₂O— in the obtained product being taken as −130.0 ppm):

δ=−82.1 ppm [3F, CF₃—CF₂CF₂O-]

δ=−83.2 ppm [3F, —CF(CF₂)—COO—CH₃]

δ=−130.0 ppm [2F, CF₃—CF₂—CF₂O-]

δ=−131.7 ppm [1F, —CF(CF₃)—COO—CH₃]

n=13.5

¹H-NMR (solvent: none, reference material: D₂O):

δ=3.7 ppm [3H, —CF(CF₃)—COO—CH₃]

### Preparation Example 2

### Preparation of F(CF₂CF₂CF₂O)ₘ—CF₂CF₂—COO—CH₃ (Compound 2)

A mixture solution of F(CF₂CF₂CF₂O)ₘ—CF₂CF₂—COON (product of Daikin Industries, Ltd., Demnum-SH, 6.0 g) obtained as a fraction by distillation, methanol (2.0 g) and p-toluenesulfonic acid (0.4 g) was refluxed at 65° C. with heating for 48 hours. The reaction mixture was washed with water and purified by column chromatography to obtain 3.4 g of Compound 2 as the desired product.

Compound 2 was a colorless transparent liquid. Compound 2 was identified by NMR with the result given below. Compound 2 was directly used for analysis.

¹⁹F-NMR (solvent: none, internal reference: —CF₂CF₂CF₂O— in the obtained product being taken as −129.7 ppm):

δ=−82.5 ppm [3F, CF₃—CF₂CF₂O-]

δ=−84.8 ppm [2F, CF₃CF₂—CF₂—O-]

δ=−86.3 ppm [2F, —CF₂—CF₂—COO—CH₂]

δ=−122.5 ppm [2F, —CF₂—CF₂—COO—CH₃]

δ=−130.7 ppm [2F, CF₃—CF₂—CF₂O—]

m=11.7

¹H-NMR (solvent: none, reference material: D₂O):

5=3.8 ppm [3H, —CF₂CF₂—COO—CH₃]

### Preparation Example 3

### Preparation of F(CF₂CF₂CF₂O)ₘ—CF₂CF₂—CH₂—OOC—CH₃ (Compound 3)

A mixture solution of F(CF₂CF₂CF₂O)ₘ—CF₂CF₂CH₂—OH (product of Daikin Industries, Ltd., Demnum-SA, 14.0 g) purified by column chromatography and acetic anhydride (20.0 g) was heated at 110° C. for 96 hours. The reaction mixture was washed with water and purified by column chromatography to obtain 14.0 g of Compound 3 as the desired product.

Compound 3 was a colorless transparent liquid. Compound 3 was identified by NMR with the result given below. Compound 3 was directly used for analysis.

¹⁹F-NMR (solvent: none, internal reference: —CF₂CF₂CF₂O— in the obtained product being taken as −129.7 ppm):

δ=−82.6 ppm [3F, CF₃—CF₂CF₂O-]

δ=−84.8 ppm [2F, CF₃CF₂—CF₂—O-]

δ=−87.0 ppm [2F, —CF₂—CF₂—CH₂—OOC—CH₃]

δ=−124.8 ppm [2F, —CF₂—CF₂—CH₂—OOC—CH₃]

δ=−130.7 ppm [2F, CF₃—CF₂—CF₂O-]

m=10.6

¹H-NMR (solvent: none, reference material: D₂O):

δ=1.9 ppm [3H, —CF₂CF₂—CH₂—OOC—CH₃]

δ=4.3 ppm [2H, —CF₂CF₂—CH₂—OOC—CH₃]

### Preparation Example 4

### Preparation of F[CF(CF₃)CF₂O]ₙ—CF(CF₃)—COO—CH₂—CF(CF₃)—[OCF₂CF(CF₃)]ₙ—F(Compound 4)

A mixture solution of Krytox-157FSL, product of DuPont (10.0 g), F[CF(CF₃)CF₂O]ₙ—CF(CF₃)—CH₂—OH (10.0 g) which was a reduced compound of the DuPont product and p-toluenesulfonic acid (1.0 g) was heated at 110° C. for 168 hours. The reaction mixture was washed with water and purified by column chromatography to obtain 2.4 g of Compound 4 as the desired product.

Compound 4 was a colorless transparent liquid. Compound 4 was identified by NMR with the result given below. Compound 4 was directly used for analysis.

¹⁹F-NMR (solvent: none, internal reference: CF₃CF₂CF₂O— in the obtained product being taken as −130.0 ppm):

δ=82.0 ppm [6F, CF₃—CF₂CF₂O—×2]

δ=83.3 ppm [6F, —CF(CF₃)—COO—CH₃×2]

δ=130.0 ppm [4F, CF₃—CF₂—CF₂O—×2]

δ=−131.7 ppm [1F, —CF(CF₃)—COO—CH₂—]

δ=133.9 ppm [1F, —COO—CH₂—CF(CF₃)—]

n=12.1

### Preparation Example 5

### Preparation of F(CF₂CF₂CF₂O)m-CF₂CF₂—CH₂—OOC—CF₂O—(CF₂CF₂O)p—(CF₂O)q—CF₂—COO—CH₂—CF₂CF₂—(OCF₂CF₂CF₂)m-F(Compound 5)

A mixture solution of Demnum-SA (10.0 g, product of Daikin Industries, Ltd.) purified by column chromatography and Fomblin Zdiac (5.0 g, product of Solvay Solexis Inc.) was heated at 150° C. for 48 hours. The reaction mixture was washed with water and purified by column chromatography to obtain 10.5 g of Compound 5 as the desired product.

Compound 5 was a colorless transparent liquid. Compound 5 was identified by NMR with the result given below. Compound 5 was directly used for analysis.

¹⁹F-NMR (solvent: none, internal reference: —CF₂CF₂CF₂O— in the obtained product being taken as −129.7 ppm):

δ=77.6 ppm [2F, —OCF₂CF₂—OCF₂—COO-]

δ=−79.2 ppm [2F, —OCF₂—OCF₂—COO-]

δ=124.1 ppm [2F, —COO—CH₂—CF₂—CF₂—×2]

m=10.4, p=9.8, q=10.8

### Preparation Example 6

### Preparation of F(CF₂CF₂CF₂O)m-CF₂CF₂—COO—CH₂—CF₂O—(CF₂CF₂O)p—(CF₂O)q—CF₂—CH₂—OOC—CF₂CF₂—(OCF₂CF₂CF₂)m-F(Compound 6)

A mixture solution of Demnum-SH (10.0 g, product of Daikin Industries, Ltd.) obtained as a fraction by distillation and Fomblin Zdol (5.0 g, product of Solvay Solexis Inc.) was heated at 150° C. for 48 hours. The reaction mixture was washed with water and purified by column chromatography to obtain 10.0 g of Compound 6 as the desired product.

Compound 6 was a colorless transparent liquid. Compound 6 was identified by NMR with the result given below. Compound 6 was directly used for analysis.

¹⁹F-NMR (solvent: none, internal reference: —CF₂CF₂CF₂O— in the obtained product being taken as −129.7 ppm):

δ=−78.5 ppm [2F, —OCF₂CF₂—OCF₂—CH₂—]

δ=−80.4 ppm [2F, —OCF₂CF₂—OCF₂—CH₂—]

δ=−122.0 ppm [2F, —CF₂—CF₂—COO—CH₂—×2]

m=10.2, p=10.1, q=10.0

Preparation of Lubrication Film with Use of Ultraviolet Rays

Each of Compounds 1 and 2 prepared in Preparation Examples 1 and 2 was diluted to a concentration of 0.1 wt. with Vertrel-XF, product of DuPont, serving as a solvent. A magnetic disk was coated over a protective carbon film thereon by the dip method to form a lubrication layer having an initial thickness of 30 angstroms. The disk coated with the lubricant was placed into an optical surface treating device equipped with a low-pressure mercury lamp which was impermeable to ultraviolet rays of 185 nm. The disk was irradiated with the lamp in the environmental atmosphere for 2 minutes to form a fixed lubricant layer over the protective carbon film. The ultraviolet rays used for this irradiation were 254 nm in main wavelength. The flowable layer (physically adsobable lubricant) remaining unbonded by the ultraviolet treatment was washed out by immersing the coated disk in a solution of Vertrel-XF, product of DuPont, whereby a lubricated magnetic disk (Example 1 or 2) was prepared. Another lubricated magnetic disk (Example 3) was also prepared by repeating the same procedure as above using Demnum-SH1, product of Daikin Industries, Ltd.

As a comparative example, a lubrication film was prepared in the same manner as above using the compound of Example 2, then washing out the flowable layer remaining unbonded by the ultraviolet treatment (physically flowable lubricant) with PF-5080 (C₈F₁₈), product of Sumitomo 3M to obtain a lubricated magnetic disk (Comparative Example 1).

As another comparative example, a lubrication film was prepared using Fomblin Ztetraol, product of Solvay Solexis Inc. First, Fomblin Ztetraol manufactured by Solvay Solexis Inc. was diluted to a concentration of 0.05 wt. with Vertrel-XF, product of DuPont, and a magnetic disk was coated by the dip method over a protective carbon layer thereon to form a lubrication layer having an initial thickness of 20 angstroms. The lubricant-coated disk was heated in a clean oven at 150° C. for 10 minutes. The flowable layer remaining unbonded by the heat treatment was washed out with Vertreol-XF manufactured by DuPont to obtain a lubricated magnetic disk (Comparative Example 2).

The lubricated magnetic disks of Examples 1, 2 and 3, and Comparative Examples 1 and 2 were evaluated with respect to the lubricant bonding ratio and contact angle, and by a spin-off test, sliding test and durability test.

### Test Example 1

### Measurement of Lubricant Bonding Ratio

The bonding ratio was measured by the following procedure. The lubricated magnetic disks (Examples 1 to 3 and Comparative Examples 1 and 2) were immersed in Vertrel-XF, product of DuPont, at room temperature for 1 minute and checked for the resulting variation in the film thickness to calculate the bonding ratio. Table 1 shows the result.

TABLE 1

| | | | film | film | |
|---|---|---|---|---|---|
| | | | thickness | thickness | |
| | | | before | after | lubricant |
| | | washing | test | test | bonding |
| | lubricant | agent | (Å) | (Å) | ratio (%) |
| Ex. 1 | Compound 1 | Vertrel- | 6.6 | 6.6 | 100 |
| | | XF | | | |
| Ex. 2 | Compound 2 | Vertrel- | 5.9 | 5.9 | 100 |
| | | XF | | | |
| Ex. 3 | Demnum-SH1 | Vertrel- | 10.5 | 10.5 | 100 |
| | | XF | | | |
| Com. | Compound 2 | PF-5080 | 7.8 | 6.3 | 81 |
| Ex. 1 | | | | | |
| Com. | ZTetraol | Vertrel- | 12.0 | 12.0 | 100 |
| Ex. 2 | | XF | | | |

### Measurement of Contact Angle

The contact angle was measured by the following procedure. Distilled water was applied dropwise to each of lubricated magnetic disks (Examples 1 to 3 and Comparative Examples 1 and 2), and the water drop applied to the disk was checked for the contact angle. Table 2 shows the result.

TABLE 2

| | | | lubricant | lubricant | contact |
|---|---|---|---|---|---|
| | | washing | film | bonding | angle |
| | lubricant | agent | thickness (Å) | ratio (%) | (°) |
| Control | no lube | — | — | — | 70 |
| | disk | | | | |
| Ex. 1 | Compound 1 | Vertrel- | 6.6 | 100 | 107.6 |
| | | XF | | | |
| Ex. 2 | Compound 2 | Vertrel- | 5.9 | 100 | 105.7 |
| | | XF | | | |
| Ex. 3 | Demnum-SH1 | Vertrel- | 10.5 | 100 | 110.4 |
| | | XF | | | |
| Com. | ZTetraol | Vertrel- | 12.0 | 100 | 104.0 |
| Ex. 2 | | XF | | | |

As will be apparent from Tables 1 and 2, the magnetic disks of Examples 1 and 2 obtained by the ultraviolet treatment and subsequent washing with a fluorine-containing solvent having a solubility parameter of at least 6.5 for removing the lubricant remaining unbonded and physically adsobable had a perfect lubricant bonding ratio of 100%, whereas the lubricated magnetic disk obtained by washing with PF-5080 (C₈F₁₈) having a solubility parameter of lower than 6.5 was merely 81% in lubricant bonding ratio. It was also found that the disks of the invention were high in water contact angle, this revealing a hydrophobic surface of low surface energy.

### Test Example 2

### Spin-Off Test of Lubricated Magnetic Disks

A spin-off test was conducted in the following manner. Each of lubricated magnetic disks (Examples 1 and 2 and Comparative Examples 1 and 2) was incorporated into a drive system and driven at a high speed of 10000 r.p.m. for 14 days in an environment of 30° C. 30% RH. Before and after the test, the disk was checked for the thickness of the lubricant film at a radial position having a radius of 30 mm to calculate the retentivity of the lubrication film. The retentivity is calculated from the equation given below.

Retentivity=Thickness of tested film÷Initial film thickness×100

Table 3 shows the result.

TABLE 3

| | | | initial | | | |
|---|---|---|---|---|---|---|
| | | | film | retentivity | | |
| | | washing | thickness | after | after | after |
| | lubricant | agent | (Å) | 0 day | 7 days | 14 days |
| Ex. 1 | Compound | Vertrel- | 6.6 | 100% | 100% | 100% |
| | 1 | XF | | | | |
| Ex. 2 | Compound | Vertrel- | 5.9 | 100% | 100% | 100% |
| | 2 | XF | | | | |
| Com. | Compound | PF-5080 | 7.8 | 100% | 85% | 82% |
| Ex. 1 | 2 | | | | | |
| Com. | ZTetraol | Vertrel- | 12.0 | 100% | 96% | 97% |
| Ex. 2 | | XF | | | | |

Table 3 shows that the magnetic disks of Examples 1 and 2 obtained by the ultraviolet treatment and subsequent washing with a fluorine-containing solvent having a solubility parameter of at least 6.5 for removing the lubricant remaining unbonded and physically adsobable did not permit the lubricant in any way, whereas the lubricated magnetic disk of Comparative Example 1 obtained by washing with PF-5080 (C₈F₁₈) having a solubility parameter of lower than 6.5 was found to spatter the lubricant.

### Test Example 3

### Contact Sliding Test for Lubricated Magnetic Disks

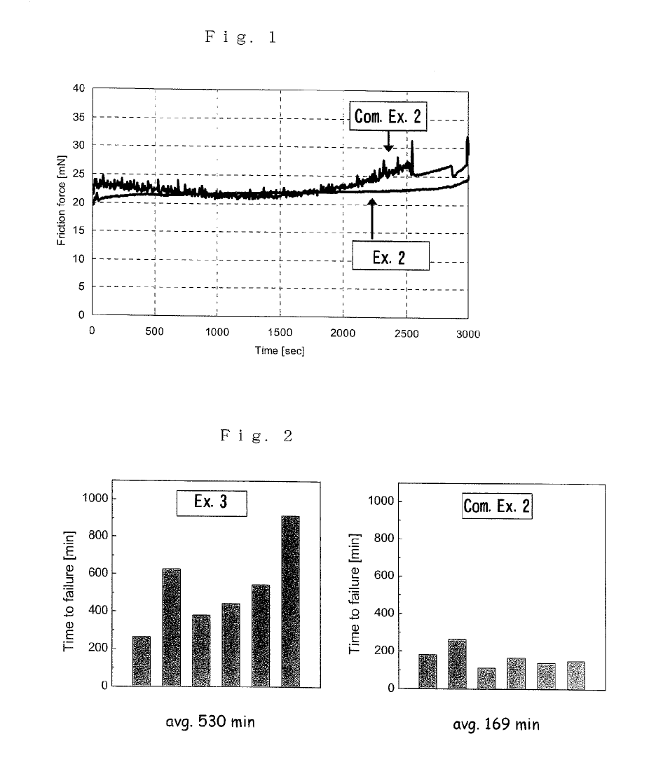

A contact sliding test was conducted in the following manner. Each of lubricated magnetic disks (Example 2 and Comparative Example 2) was incorporated into a friction tester and caused to rotate at 90 r.p.m to measure the resulting frictional force by being pressed on with a sapphire ball at a radial position having a radius of 30 mm. FIG. 1 shows the result.

### Test Example 4

### Durability Test for Lubricated Magnetic Disks

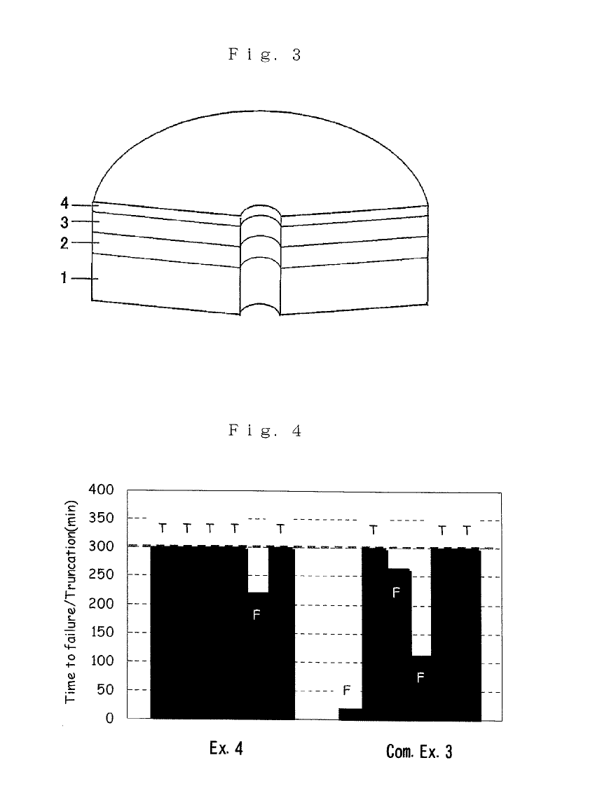

A durability test (time-to-failure test) was conducted in the following manner. Each of lubricated magnetic disks (Example 3 and Comparative Example 2) was incorporated into a HDD tester and caused to rotate at 10000 r.p.m. in a reduced-pressure atmosphere of 0.33 atm. with a head levitated at a radial position, having a radius of 30 mm, above the disk. The time taken for the disk to crash was measured using an AE sensor and friction sensor. FIG. 2 shows the result.

FIGS. 1 and 2 show that the lubricated magnetic disk of Example 2 prepared by the ultraviolet treatment with use of a low-pressure mercury lamp having a main wavelength of 254 and impermeable to ultraviolet rays of 185-nm wavelength was diminished in variations in frictional force to exhibit high durability in the event of contact sliding. The disk of Example 3 prepared in the same manner as above was also found to exhibit excellent durability by the HDD test wherein the head was levitated.

These results reveal that without the necessity of providing an inert gas atmosphere or a vacuum environment, the compound (Q) of the present invention forms a fixed phase over the protective carbon film of magnetic disks when irradiated with ultraviolet rays having a main wavelength of 254 nm and afforded by a low-pressure mercury lamp which is impermeable to ultraviolet rays of 185 nm in wavelength. The lubricated magnetic disk obtained exhibits low surface energy, will not permit the fixed lubricant film to spatter even if rotated at a high speed and highly durable in the event of contact sliding.

Formation of Lubrication Film Over the Surface of Protective Carbon Film on Magnetic Head with Use of Ultraviolet Rays:

A perfluoropolyether having a carboxyl group at the terminal (Demnum-SH, product of Daikin Industries, Ltd.) is diluted to a concentration of 0.1 wt. % with Vertreol-XF, product of DuPont and serving as a solvent. A magnetic head is then coated over the surface of a protective carbon film thereon by the dip method. The lubricant-coated magnetic head is placed into an optical surface treating device having installed therein a low-pressure mercury lamp impermeable to ultraviolet rays of 185 nm in wavelength and irradiated in the open atmosphere with ultraviolet rays for 2 minutes to form a fixed lubricant layer over the protective carbon film. The ultraviolet rays to be applied at this time are 254 in main wavelength. The flowable layer remaining unadsorbed by the ultraviolet treatment was washed out with Vertreol-XF, product of DuPont and serving as a solvent, to prepare a lubricated magnetic head (Example 4).

As a comparative example, an untreated magnetic head (Comparative Example 3) was used. The magnetic heads obtained in Example 4 and Comparative Example 3 were tested for durability. Test Example 5 Durability Test:

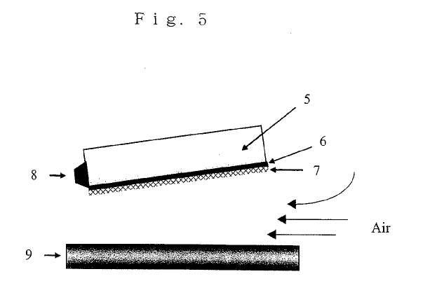

A durability test was conducted by the following procedure. Magnetic heads (Example 4 and Comparative Example 1) and magnetic disks coated with Fomblin Z-Tetraol serving as a lubricant were incorporated into respective HDD (hard disk drive) testers, and the time taken for each of the lubricated magnetic disks to crash was measured by detecting AE (acoustic emission) while rotating the disk at 10,000 r.p.m. under a reduced-pressure environment (contact sliding) of 0.33 atm. FIG. 4 shows the result.

FIG. 4 shows that when tested for durability, the magnetic head of Example 4 exhibited satisfactory durability even when rotated at a high speed in the reduced-pressure environment (contact sliding movement) of 0.33 atm.

The foregoing results reveal that the magnetic head having the lubrication film of the invention had outstanding durability even if rotated at a high speed against contact sliding under reduced pressure.

### INDUSTRIAL APPLICABILITY

The magnetic disk or magnetic head is coated over the protective carbon film thereon with the compound (Q) of the present invention, and the resulting coating is then irradiated with ultraviolet rays which are 240 to 380 nm, preferably 240 to 300 nm, and more preferably 254 nm, in main wavelength using a low-pressure mercury lamp which is impermeable to ultraviolet rays, 185 nm in wavelength, whereby a fixed layer can be formed. Furthermore, the lubrication film formed by the ultraviolet treatment will not spatter even if the disk is rotated at a high speed, enabling the magnetic disk or head to exhibit high durability even in the event of contact sliding.

The compound of the invention is capable of forming a fixed phase when exposed to ultraviolet rays of a low-pressure mercury lamp which blocks the passage of ultraviolet rays having a wavelength of 185 nm, because when the compound absorbs ultraviolet rays of 254 nm, CO₂ becomes released from the site of the carboxyl group or ester bond, simultaneously producing a terminal radical on the perfluoropolyether chain and presumably forming a covalent bond with an unsaturated bond or dangling bond of the protective carbon film which is a ground layer for the lubricant (Nonpatent Literature 2).
Nonpatent Literature 2: P. H. Kasai, Chemistry of Materials, 1994, 6, 1581

1. A magnetic disk having a lubrication film of a lubricant bonded in a ratio of at least 99% to a protective carbon film on a magnetic disk member, the lubricant containing a perfluoropolyether
compound (Q) 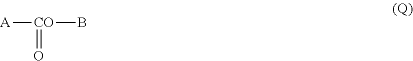
wherein A is alkyl having 1 to 10 carbon atoms, fluoroalkyl having 1 to 10 carbon atoms, F(CF₂CF₂CF₂O)m-CF₂CF₂—, F[CF(CF₃)CF₂O]n-CF(CF₃)— or a group of the formula (a) given below, B is hydrogen, alkyl having 1 to 10 carbon atoms, fluoroalkyl having 1 to 10 carbon atoms, F(CF₂CF₂CF₂O)m-CF₂CF₂—CH₂—, F[CF(CF₃)CF₂O]n-CF(CF₃)—CH₂— or a group of the formula (b) given below 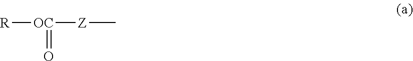
wherein R is hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—, Z is —CF₂O(CF₂CF₂O)rCF₂—,
—CF₂O(CF₂CF₂O)p(CF₂O)qCF₂— or —CF₂CF₂O(CF₂CF₂CF₂O)m-CF₂CF₂— 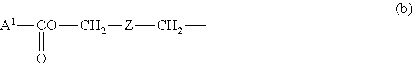
wherein A¹ is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, Z is the same as defined above, and m, n, p, q and r are each a real number of 5 to 50.

2. A magnetic head having a lubrication film of a lubricant bonded in a ratio of at least 99% to a protective carbon film on a magnetic head member, the lubricant containing a perfluoropolyether compound of claim 1.

3. A magnetic disk having a lubrication film of a lubricant bonded in a ratio of at least 100% to a protective carbon film on a magnetic disk member, the lubricant containing a perfluoropolyether compound of claim 1.

4. A magnetic head having a lubrication film of a lubricant bonded in a ratio of at least 100% to a protective carbon film on a magnetic head member, the lubricant containing a perfluoropolyether compound of claim 1.

5. A process for preparing a lubrication film comprising a lubricant having a bonding ratio of at least 99%, the process comprising coating a protective film on a magnetic disk or magnetic head with a lubricant containing a perfluoropolyether compound of claim 1, irradiating the resulting coating with ultraviolet rays having a main wavelength of 240 to 380 nm using a low-pressure mercury lamp impermeable to ultraviolet rays having a wavelength of 185 nm to form a fixed lubricant layer, and washing out the lubricant remaining unbonded and physically adsobable with a fluorine-containing solvent having a solubility parameter of at least 6.5.

6. A process for preparing a lubrication film comprising a lubricant having a bonding ratio of at least 99% as defined in claim 5 wherein the ultraviolet rays having a main wavelength of 254 nm is used as the ultraviolet rays having a main wavelength of 240 to 380 nm.

7. A process for preparing a lubrication film comprising a lubricant having a bonding ratio of at least 99% as defined in claim 6 wherein at least one of compounds (I)˜(IV) is used as the perfluoropolyether compound,
Compounds (I) wherein A is F(CF₂CF₂CF₂O)m-CF₂CF₂— or F[CF(CF₃)CF₂O]n-CF(CF₃)—, B is hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—,
Compounds (II) wherein A is alkyl having 1 to 10 carbon atoms or fluoroalkyl having 1 to 10 carbon atoms, B is F(CF₂CF₂CF₂O)m-CF₂CF₂—CH₂— or F[CF(CF₃)CF₂O]n-CF(CF₃)—CH₂—,
Compounds (III) wherein A is ROCO—Z—, R being hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—, Z is —CF₂O(CF₂CF₂O)rCF₂—, —CF₂O(CF₂CF₂O)p(CF₂O)qCF₂— or —CF₂CF₂O(CF₂CF₂CF₂O)m-CF₂CF₂—, and B is hydrogen, alkyl having 1 to 10 carbon atoms, fluoroalkyl having 1 to 10 carbon atoms, F(CF₂CF₂CF₂O)m-CF₂CF₂—CH₂— or F[CF(CF₃)CF₂O]n-CF(CF₃)—CH₂—, and
Compounds (IV) wherein A is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, B is A¹COOCH₂—Z—CH₂—, A¹ is alkyl having 1 to 10 carbon atoms, fluoroalkyl having 1 to 10 carbon atoms, F(CF₂CF₂CF₂O)m-CF₂CF₂— or F[CF(CF₃)CF₂O]n-CF(CF₃)—, Z is —CF₂O(CF₂CF₂O)rCF₂—, —CF₂O(CF₂CF₂O)p(CF₂O)qCF₂— or —CF₂CF₂O(CF₂CF₂CF₂O)m-CF₂CF₂—.

8. A magnetic disk provided over a surface of a protective carbon film on a magnetic disk member with a lubrication film obtained by the process defined in claim 5.

9. A magnetic disk provided over a surface of a protective carbon film on a magnetic disk member with a lubrication film obtained by the process defined in claim 6.

10. A magnetic disk provided over a surface of a protective carbon film on a magnetic disk member with a lubrication film obtained by the process defined in claim 7.

11. A magnetic head provided over a surface of a protective carbon film on a magnetic head member with a lubrication film obtained by the process defined in claim 5.

12. A magnetic head provided over a surface of a protective carbon film on a magnetic head member with a lubrication film obtained by the process defined in claim 6.

13. A magnetic head provided over a surface of a protective carbon film on a magnetic head member with a lubrication film obtained by the process defined in claim 7.
